(19) United States
(12) Patent Application Publication
(10) Pub. No.: US 2026/0208844 A1
(43) Pub. Date: Jul. 23, 2026

(54) POD PROPULSION UNIT

(71) Applicant: ABB OY, Helsinki (FI)

(72) Inventors: Petri Pellinen, Helsinki (FI); Veli-Pekka Peljo, Helsinki (FI); Sakari Siipilehto, Helsinki (FI)

(73) Assignee: ABB OY, Helsinki (FI)

(21) Appl. No.: 19/456,453

(22) Filed: Jan. 22, 2026

(30) Foreign Application Priority Data
Jan. 23, 2025 (EP) 25153550.6

(51) Int. Cl. B63H 23/32

(52) U.S. Cl. CPC B63H 23/321

(57) ABSTRACT

A pod propulsion unit includes a housing, a support arm, a propeller shaft rotatably supported within the housing via a first bearing arrangement having a first bearing housing, first fastening means for fastening the first bearing housing to the housing, wherein the first bearing housing and the housing are spaced apart from one another using a first electrical insulation arrangement arranged between the first bearing housing and the housing and configured to electrically insulate the first bearing housing from the housing. The first electrical insulation arrangement includes first ceramic insulators, and the first ceramic insulators contact the first bearing housing and the housing so as to space apart the first bearing housing and the housing from one another.

### CROSS-REFERENCE TO RELATED APPLICATIONS

The instant application claims priority to European Patent Application No. 25153550.6, filed on Jan. 23, 2025, which is incorporated herein in its entirety by reference.

### FIELD OF THE DISCLOSURE

The present disclosure generally relates to a pod propulsion system for a marine vessel.

### BACKGROUND OF THE INVENTION

Bearing arrangements rotatably supporting a propeller shaft in the housing of pod propulsion units are normally electrically insulated from the housing of the pod propulsion unit to prevent electric current flow through the bearing arrangements. One known way to electrically insulate them is to provide an epoxy layer such as epoxy reinforced glass fiber between the bearing housing of the bearing arrangement and a frame of the housing of the pod propulsion unit to which the bearing housing of the bearing arrangement is attached to so as to space apart and electrically insulate the bearing housing of the bearing arrangement from the frame of the housing of the pod propulsion unit. To be able to properly electrically insulate the bearing housing of the bearing arrangement from the frame means of the housing of the pod propulsion unit, a thick epoxy layer is required. This leads to increased mechanical risks as the epoxy layer is much softer than steel which both the housing and the bearing housing are usually made of. Epoxy can also absorb moisture, and this affects negatively the electrical insulation ability of the epoxy.

### BRIEF SUMMARY OF THE INVENTION

The present disclosure generally describes a pod propulsion unit having electrical insulation arrangement between the bearing housing of the bearing arrangement and the housing of the pod propulsion unit, which electrical insulation arrangement is capable of electrically insulating the bearing housing of the bearing arrangement from the housing of the pod propulsion unit and that is mechanically robust.

### BRIEF DESCRIPTION OF THE SEVERAL VIEWS OF THE DRAWING(S)

FIG. 1 partial cross section of a pod propulsion unit in accordance with the disclosure.

FIG. 2 is a detail view of a first embodiment of the pod propulsion unit of FIG. 1.

FIG. 3 is a detail view of a second embodiment of the pod propulsion unit of FIG. 1.

FIG. 4 is a section view along A-A in FIG. 3.

FIG. 5 is a detail view of a third embodiment of the pod propulsion unit of FIG. 1.

FIG. 6 is a detail view of a fourth embodiment of the pod propulsion unit of FIG. 1.

FIG. 7 is a detail view of a fifth embodiment of the pod propulsion unit of FIG. 1.

FIG. 8 is a detail view of a sixth embodiment of the pod propulsion unit of FIG. 1.

FIG. 9 is a detail view of a seventh embodiment of the pod propulsion unit of FIG. 1.

FIG. 10 is a detail view of an eight embodiment of the pod propulsion unit of FIG. 1.

FIG. 11 is a detail view of a ninth embodiment of the pod propulsion unit of FIG. 1, taken at D-D in FIGS. 12 and 13.

FIG. 12 is a detail view of the ninth embodiment of the pod propulsion unit illustrated in FIG. 11 at B-B.

FIG. 13 is a detail view of the ninth embodiment of the pod propulsion unit illustrated in FIG. 11 at C-C.

### DETAILED DESCRIPTION OF THE INVENTION

The propulsion unit 1 and some variants and embodiments of the pod propulsion unit 1 will be described in greater detail. The pod propulsion unit 1 comprises a housing 2. The pod propulsion unit 1 comprises a support arm 3 attached to the housing 2 and configured to fasten the housing 2 to a hull 4 of a marine vessel. The pod propulsion unit 1 comprises a propeller shaft 5. The propeller shaft 5 is rotatable supported within the housing 2 by means of at least a first bearing arrangement 6 having a first bearing housing 7 and by means of at least a second bearing arrangement 9 having a second bearing housing 10.

The pod propulsion unit 1 comprises first fastening means 11 for fastening the first bearing housing 7 to the housing 2. The first bearing housing 7 and the housing 2 are spaced apart from one another by means of a first electrical insulation arrangement 13 arranged between the first bearing housing 7 and the housing 2 and configured to electrically insulate the first bearing housing 7 from the housing 2.

The pod propulsion unit 1 can comprise second fastening means 40 for fastening the second bearing housing 10 to the housing 2 such as to a second frame means (not illustrated in the figures) of the housing 2. The second bearing housing 10 can alternatively be an integral part of the housing 2.

The pod propulsion unit 1 comprises a propeller 14 attached to the propeller shaft 5. The first bearing housing 7 have first holes 15 aligned with second holes 16 in the housing 2 to form aligned first holes 15 and second holes 16. Aligned first holes 15 and second holes 16 means here that a first hole 15 need not necessarily to be coaxial or even to be fully aligned with a second hole 16.

In the illustrated embodiment, the first fastening means 11 comprises first elongated fasteners 17 arranged in aligned first holes 15 and second holes 16. The first electrical insulation arrangement 13 comprises first ceramic insulators 42. The first ceramic insulators 42 contact the first bearing housing 7 and contact the housing 2 so as to space apart the first bearing housing 7 and the housing 2 from one another.

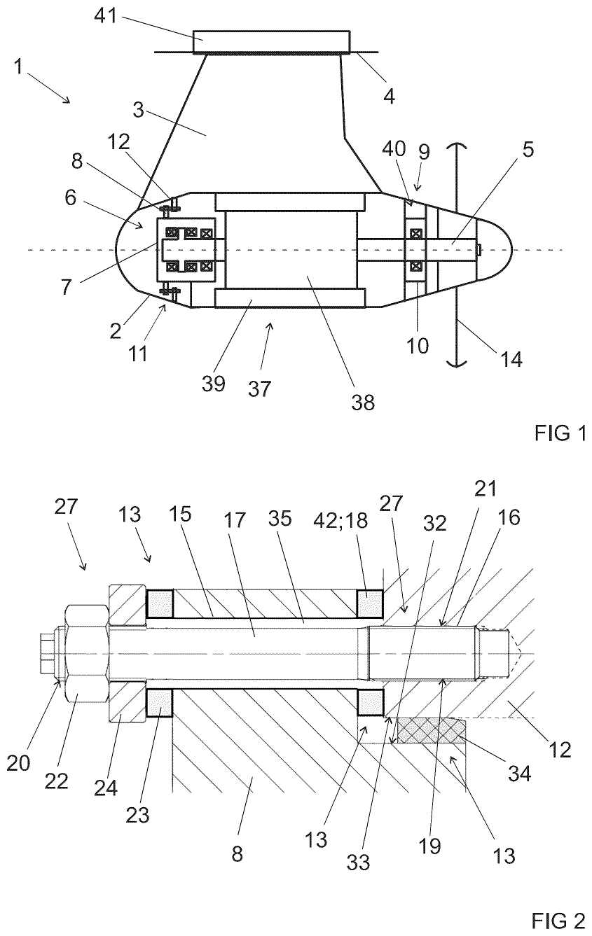

At least some of the first ceramic insulators 42 are preferably, but not necessarily, as in the embodiments illustrated in FIGS. 1 to 10, in the form of first ceramic washers 18 penetrated or passed through by said first elongated fasteners 17 arranged in aligned first holes 15 and second holes 16.

If at least some of the first ceramic insulators 42 are in the form of first ceramic washers 18 penetrated or passed through by said first elongated fasteners 17 arranged in aligned first holes 15 and second holes 16, the cross-section such as the inner diameter of the inner cylindric surface of the first ceramic washers 18 can be larger than the cross-section such as larger than the outer diameter of said first elongated fasteners 17 of the first fastening means 11 at the first ceramic washers 18. This to provide an electrically insulating air gap (not marked with a reference numeral) between the first ceramic washers 18 and the first elongated fasteners 17 at the first ceramic washers 18.

The first bearing housing 7 is preferably, but not necessarily, as in the embodiments of the pod propulsion unit 1 illustrated in the figures, provided with a first flange portion 8, and the first holes 15 are preferably, but not necessarily, provided in the first flange portion 8. The first flange portion 8 can be in the form of a separate part that is fastened to the first bearing housing 7. It is also possible that the first flange portion 8 is in the form of a part that is integrally formed with the first bearing housing 7.

The housing 2 is preferably, but not necessarily, as in the embodiments of the pod propulsion unit 1 illustrated in the figures, provided with a first frame means 12, and the second holes 16 are preferably, but not necessarily, provided in the first frame means 12. The first frame means 12 can be in the form of a separate part that is fastened to the housing 2. It is also possible that the first frame means 12 is in the form of a part that is integrally formed with the housing 2.

If the first bearing housing 7 is provided with a first flange portion 8 in which the first holes 15 are provided and if the housing 2 is provided with a first frame means 12 in which the second holes 16 are provided, the first holes 15 in the first flange portion 8 of the first bearing housing 7 are aligned with the second holes 16 in the first frame means 12 in the housing 2 to provide said aligned first holes 15 and second holes 16. In such case, the first elongated fasteners 17 are arranged in the aligned first holes 15 in the first flange portion 8 of the first bearing housing 7 and in the second holes 16 in the first frame means 12 in the housing 2 and the first ceramic insulators 42 contact the first flange portion 8 of the first bearing housing 7 and contact the first frame means 12 of the housing 2 so as to space apart the first flange portion 8 of the first bearing housing 7 and the first frame means 12 of the housing 2 from one another so as to electrically insulate the first flange portion 8 of the first bearing housing 7 from the first frame means 12 of the housing 2.

The first fastening means 11 comprises preferably, but not necessarily, pressing means 27 configured to cooperate with the first elongated fasteners 17 so as to press the first bearing housing 7 and the housing 2 towards each other so that the first ceramic insulators 42 contacting the first bearing housing 7 and contacting the housing 2 are pressed between the first bearing housing 7 and the housing 2. If the first bearing housing 7 is provided with a first flange portion 8 in which the first holes 15 are provided and if the housing 2 is provided with a first frame means 12 in which the second holes 16 are provided, the pressing means 27 is configured to cooperate with the first elongated fasteners 17 so as to press the first flange portion 8 of the first bearing housing 7 and the first frame means 12 of the housing 2 towards each other so that the first ceramic insulators 42 contacting the first flange portion 8 of the first bearing housing 7 and contacting the first frame means 12 housing 2 are pressed between the first flange portion 8 of the first bearing housing 7 and the first frame means 12 of the housing 2.

The first ceramic insulators 42 can, for example, at least partly be made of at least one of aluminum oxide and zirconium oxide. The number of first elongated fasteners 17 and the number of first ceramic insulators 42, which can be first ceramic washers 18, is preferably, but not necessarily, between 10 and 30.

If the first fastening means 11 comprises pressing means 27, the first electrical insulation arrangement 13 comprising preferably, but not necessarily, as in the embodiments of the pod propulsion unit 1 illustrated in figures, second ceramic washers 23 penetrated or passed through by said first elongated fasteners 17 arranged in aligned first holes 15 and second holes 16, wherein the second ceramic washers 23 contact the first bearing housing 7 and contact the pressing means 27 so as to space apart the first bearing housing 7 and the pressing means 27 from one another and so as to electrically insulate the first bearing housing 7 and the pressing means 27 from one another. If the first bearing housing 7 is provided with a first flange portion 8 in which the first holes 15 are provided, the second ceramic washers 23 contact the first flange portion 8 of the first bearing housing 7 and contact the pressing means 27 so as to space apart the first flange portion 8 of the first bearing housing 7 and the pressing means 27 from one another and so as to electrically insulate the first flange portion 8 of the first bearing housing 7 and the pressing means 27 from one another. The second ceramic washers 23 can for example at least partly be made of at least one of aluminum oxide and zirconium oxide.

The cross-section such as the inner diameter of the inner cylindric surface of the second ceramic washers 23 can be larger than the cross-section such as larger than the outer diameter of said first elongated fasteners 17 of the first fastening means 11 at the second ceramic washers 23. This provides an electrically insulating air gap (not marked with a reference numeral) between the second ceramic washers 23 and the first elongated fasteners 17 at the second ceramic washers 23.

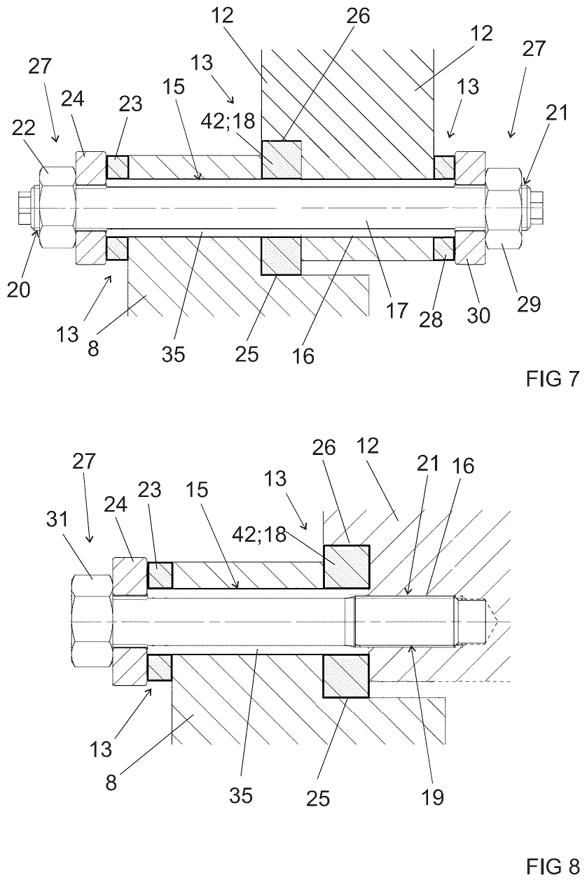

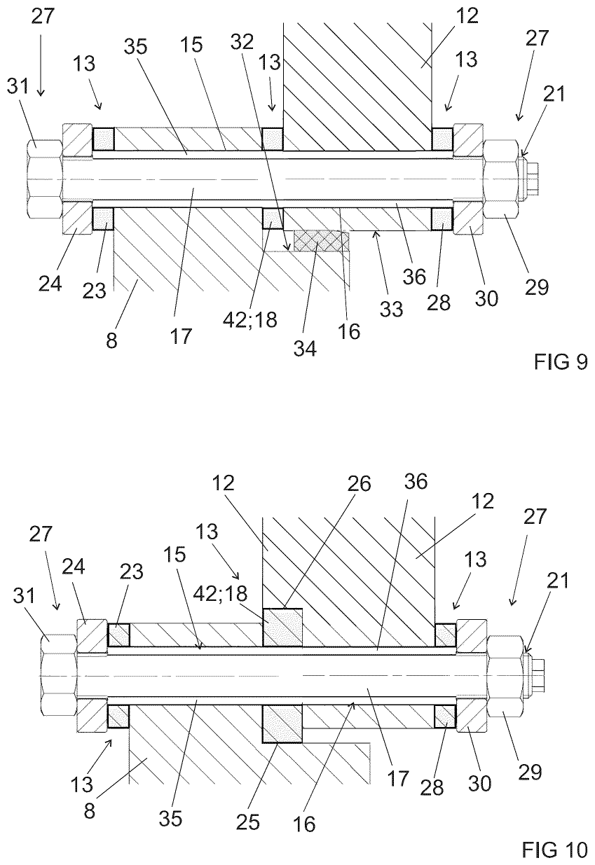

If the first fastening means 11 comprises pressing means 27, the first electrical insulation arrangement 13 comprising preferably, but not necessarily, as in the third embodiment of the pod propulsion unit 1 illustrated in FIG. 5, as in the fifth embodiment of the pod propulsion unit 1 illustrated in FIG. 7, as in the seventh embodiment of the pod propulsion unit 1 illustrated in FIG. 9, and as in the eighth embodiment of the pod propulsion unit 1 illustrated in FIG. 10 third ceramic washers 28 penetrated or passed through by said first elongated fasteners 17 arranged in aligned first holes 15 and second holes 16, wherein the third ceramic washers 28 contact the housing 2 and contact the pressing means 27 so as to space apart the housing 2 and the pressing means 27 from one another and so as to electrically insulate the housing 2 and the pressing means 27 from one another. If the housing 2 is provided with a first frame means 12 in which the second holes 16 are provided, the third ceramic washers 28 contact the first frame means 12 of the housing 2 and contact the pressing means 27 so as to space apart the first frame means 12 of the housing 2 and the pressing means 27 from one another and so as to electrically insulate the first frame means 12 of the housing 2 and the pressing means 27 from one another. The third ceramic washers 28 can for example at least partly be made of at least one aluminum oxide and zirconium oxide.

The cross-section such as the inner diameter of the inner cylindric surface of the third ceramic washers 28 can be larger than the cross-section such as larger than the outer diameter of said first elongated fasteners 17 of the first fastening means 11 at the third ceramic washers 28. This provides an electrically insulating air gap (not marked with a reference numeral) between the third ceramic washers 28 and the first elongated fasteners 17 at the third ceramic washers 18.

The cross-section such as the outer diameter of the first elongated fasteners 17 is preferably, but not necessarily, as in the embodiments of the propulsion unit 1 illustrated in figures, smaller than the cross-section such as smaller than the inner diameter of the first holes 15 in the first bearing housing 7 at the first holes 15 in the first bearing housing 7 so that the first elongated fasteners 17 and the first bearing housing 7 are spaced apart from one another so as to provide a first electrically insulating air gap 35 between the first elongated fasteners 17 and the first bearing housing 7 at the first holes 15 so as to electrically insulate the first elongated fasteners 17 from the first bearing housing 7. If the first bearing housing 7 is provided with a first flange portion 8 in which the first holes 15 are provided, the cross-section such as the outer diameter of the first elongated fasteners 17 is preferably, but not necessarily, as in the embodiments of the propulsion unit 1 illustrated in figures, smaller than the cross-section such as smaller than the inner diameter of the first holes 15 in the first flange portion 8 of the first bearing housing 7 at the first holes 15 in the first flange portion 8 of the first bearing housing 7 so that the first elongated fasteners 17 and the first flange portion 8 of the first bearing housing 7 being spaced apart from one another so as to provide a first electrically insulating air gap 35 at the first holes 15 between the first elongated fasteners 17 and the first flange portion 8 of the bearing housing 7 so as to electrically insulate the first elongated fasteners 17 from the first flange portion 8 of the first bearing housing 7.

The cross-section such as the outer diameter of the first elongated fasteners 17 can, as in the third embodiment of the propulsion unit 1 illustrated in FIG. 5, as in the fifth embodiment of the propulsion unit 1 illustrated in FIG. 7, as in the seventh embodiment of the propulsion unit 1 illustrated in FIG. 9, and as in the eighth embodiment of the propulsion unit 1 illustrated in FIG. 10, be smaller than the cross-section such as smaller than the inner diameter of the second holes 16 in the housing 2 at the second holes 16 in the housing 2 so that the first elongated fasteners 17 and the housing 2 are spaced apart from one another so as to provide a second electrically insulating air gap 36 between the first elongated fasteners 17 and the housing 2 at the second holes 16 so as to electrically insulate the first elongated fasteners 17 from the housing 2. If the housing 2 is provided with a first frame means 12 in which the second holes 16 are provided, the cross-section such as the outer diameter of the first elongated fasteners 17 can, as in the third embodiment of the propulsion unit 1 illustrated in FIG. 5, as in the fifth embodiment of the propulsion unit 1 illustrated in FIG. 7, as in the seventh embodiment of the propulsion unit 1 illustrated in FIG. 9, and as in the eighth embodiment of the propulsion unit 1 illustrated in FIG. 10, be smaller than the cross-section such as smaller than the inner diameter of the second holes 16 in the first frame means 12 of the housing 2 at the second holes 16 in the first frame means 12 of the housing 2 so that the first elongated fasteners 17 and the first frame means 12 of the housing 2 are spaced apart from one another at the second holes 16 so as to provide a second electrically insulating air gap 36 between the first elongated fasteners 17 and the first frame means 12 of the housing 2 so as to electrically insulate the first elongated fasteners 17 from the first frame means 12 of the housing 2.

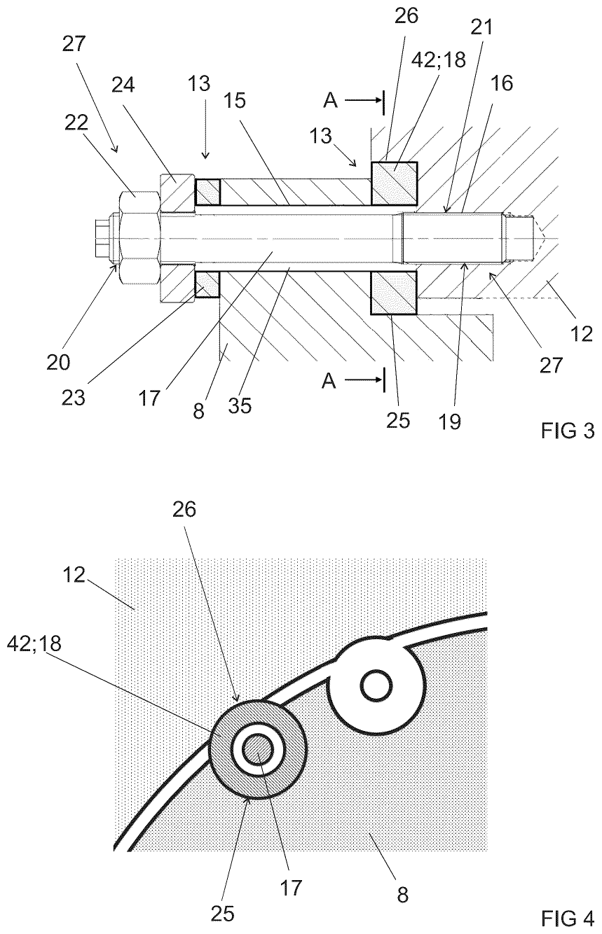

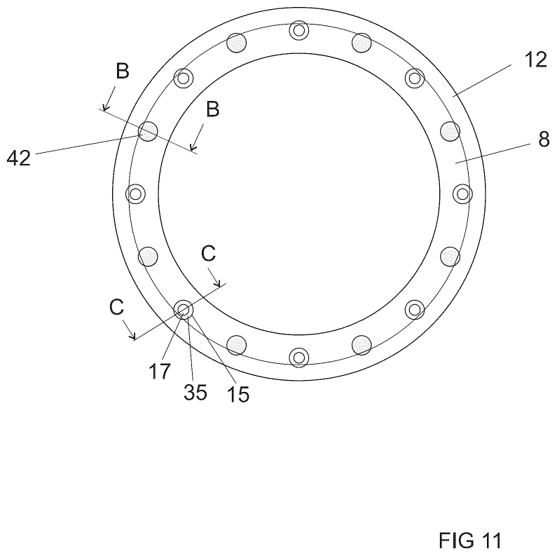

If the first fastening means 11 comprises pressing means 27, the first elongated fasteners 17 comprises preferably, but not necessarily, as in the first embodiment of the pod propulsion unit 1 illustrated in FIG. 2, as in the second embodiment of the pod propulsion unit 1 illustrated in FIG. 3, as in the third embodiment of the pod propulsion unit 1 illustrated in FIG. 5, as in the fifth embodiment of the pod propulsion unit 1 illustrated in FIG. 7, and as in the ninth embodiment of the pod propulsion unit 1 illustrated in FIGS. 11 to 13 a first outer threaded end section 20 outside the aligned first holes 15 and second holes 16, wherein the pressing means 27 comprises a first nut 22 threadingly engaging the first outer threaded end section 20 and configured to press the first bearing housing 7 and the housing 2 towards each other. If the first bearing housing 7 is provided with a first flange portion 8 in which the first holes 15 are provided and if the housing 2 is provided with a first frame means 12 in which the second holes 16 are provided and if the first fastening means 11 comprises pressing means 27, the first elongated fasteners 17 comprises preferably, but not necessarily, as in the first embodiment of the pod propulsion unit 1 illustrated in FIG. 2, as in the second embodiment of the pod propulsion unit 1 illustrated in FIG. 3, as in the third embodiment of the pod propulsion unit 1 illustrated in FIG. 5, as in the fifth embodiment of the pod propulsion unit 1 illustrated in FIG. 7, and as in the ninth embodiment of the pod propulsion unit 1 illustrated in FIGS. 11 to 13, a first outer threaded end section 20 outside the aligned first holes 15 and second holes 16, wherein the pressing means 27 comprises a first nut 22 threadably engaging the first outer threaded end section 20 and configured to press the first flange portion 8 of the first bearing housing 7 and the first frame means 12 of the housing 2 towards each other. If the first fastening means 11 comprises pressing means 27 comprising first nuts 22, as presented, the first electrical insulation arrangement 13 comprising preferably, but not necessarily, as in the embodiments of the pod propulsion unit 1 illustrated in figures, second ceramic washers 23 penetrated or passed through by said first elongated fasteners 17 arranged in aligned first holes 15 and second holes 16, wherein the second ceramic washers 23 contacting the first bearing housing 7 and contacting the first nuts 22 so as to space apart the first bearing housing 7 and the first nuts 22 from one another so as to electrically insulate the first bearing housing 7 and the first nuts 22 from one another. If the first bearing housing 7 is provided with a first flange portion 8 in which the first holes 15 are provided and if the housing 2 is provided with a first frame means 12 in which the second holes 16 are provided and if the first fastening means 11 comprises pressing means 27 and if the first fastening means 11 comprises pressing means 27 comprising first nuts 22, as presented, the first electrical insulation arrangement 13 comprising preferably, but not necessarily, as in the embodiments of the pod propulsion unit 1 illustrated in figures, second ceramic washers 23 penetrated or passed through by said first elongated fasteners 17 arranged in aligned first holes 15 and second holes 16, wherein the second ceramic washers 23 contacting the first flange portion 8 of the first bearing housing 7 and contacting the first nuts 22 so as to space apart the first flange portion 8 of the first bearing housing 7 and the first nuts 22 from one another so as to electrically insulate the first flange portion 8 of the first bearing housing 7 and the first nuts 22 from one another. A first metal washer 24 can be provided at the first elongated fasteners 17 between the first nut 22 and the second ceramic washers 23 as in the first embodiment of the pod propulsion unit 1 illustrated in FIG. 2, as in the second embodiment of the pod propulsion unit 1 illustrated in FIG. 3, as in the third embodiment of the pod propulsion unit 1 illustrated in FIG. 5, as in the fifth embodiment of the pod propulsion unit 1 illustrated in FIG. 7, and as in the ninth embodiment of the pod propulsion unit 1 illustrated in FIGS. 11 to 13. Spring washers (not illustrated) such as at least one Belleville washer can also be provided at the first elongated fasteners 17 between the first nut 22 and the second ceramic washers 23 to compensate for creeping.

If the first fastening means 11 comprises pressing means 27, the first elongated fasteners 17 comprises preferably, but not necessarily, as in the third embodiment of the pod propulsion unit 1 illustrated in FIG. 5 and as in the fifth embodiment of the pod propulsion unit 1 illustrated in FIG. 7, a first outer threaded end section 20 outside the aligned first holes 15 and second holes 16 and a second outer threaded end section 21 outside the aligned first holes 15 and second holes 16, wherein the pressing means 27 configured to press the first bearing housing 7 and the housing 2 towards each other comprises a first nut 22 threadingly engaging the first outer threaded end section 20 and a second nut 29 threadingly engaging the second outer threaded end section 21. If the first bearing housing 7 is provided with a first flange portion 8 in which the first holes 15 are provided and if the housing 2 is provided with a first frame means 12 in which the second holes 16 are provided and if the first fastening means 11 comprises pressing means 27, the first elongated fasteners 17 comprises preferably, but not necessarily, as in the third embodiment of the pod propulsion unit 1 illustrated in FIG. 5 and as in the fifth embodiment of the pod propulsion unit 1 illustrated in FIG. 7, a first outer threaded end section 20 outside the aligned first holes 15 and second holes 16 and a second outer threaded end section 21 outside the aligned first holes 15 and second holes 16, wherein the pressing means 27 configured to press the first flange portion 8 of the first bearing housing 7 and the first frame means 12 of the housing 2 towards each other comprises a first nut 22 threadingly engaging the first outer threaded end section 20 and a second nut 29 threadingly engaging the second outer threaded end section 21. If the first fastening means 11 comprises pressing means 27 comprising first nuts 22 and second nuts 29, as presented, the first electrical insulation arrangement 13 comprising preferably, but not necessarily, as in the third embodiment of the pod propulsion unit 1 illustrated in FIG. 5 and as in the fifth embodiment of the pod propulsion unit 1 illustrated in FIG. 7, second ceramic washers 23 penetrated or passed through by said first elongated fasteners 17 arranged in aligned first holes 15 and second holes 16, wherein the second ceramic washers 23 contacting the first bearing housing 7 and contacting the first nuts 22 so as to space apart the first bearing housing 7 and the first nuts 22 from one another and so as to electrically insulate the first bearing housing 7 and the first nuts 22 from one another and third ceramic washers 28 penetrated or passed through by said first elongated fasteners 17 arranged in aligned first holes 15 and second holes 16, and wherein the third ceramic washers 28 contacting the housing 2 and contacting the second nuts 29 so as to space apart the housing 2 and the second nuts 29 from one another and so as to electrically insulate the housing 2 and the second nuts 29 from one another. If the first bearing housing 7 provided with a first flange portion 8 in which the first holes 15 are provided and if the housing 2 is provided with a first frame means 12 in which the second holes 16 are provided and if the first fastening means 11 comprises pressing means 27 comprising first nuts 22 and second nuts 29, as presented, the first electrical insulation arrangement 13 comprising preferably, but not necessarily, as in the third embodiment of the pod propulsion unit 1 illustrated in FIG. 5 and as in the fifth embodiment of the pod propulsion unit 1 illustrated in FIG. 7, second ceramic washers 23 penetrated or passed through by said first elongated fasteners 17 arranged in aligned first holes 15 and second holes 16, wherein the second ceramic washers 23 contacting the first bearing housing 7 and contacting the first nuts 22 so as to space apart the first bearing housing 7 and the first nuts 22 from one another and so as to electrically insulate the first bearing housing 7 and the first nuts 22 from one another and third ceramic washers 28 penetrated or passed through by said first elongated fasteners 17 arranged in aligned first holes 15 and second holes 16, and wherein the third ceramic washers 28 contacting the housing 2 and contacting the second nuts 29 so as to space apart the housing 2 and the second nuts 29 from one another and so as to electrically insulate the housing 2 and the second nuts 29 from one another. A first metal washer 24 can, as in the third embodiment of the pod propulsion unit 1 illustrated in FIG. 5, and as in the fourth embodiment of the pod propulsion unit 1 illustrated in FIG. 7, be provided at the first elongated fasteners 17 between the first nut 22 and the second ceramic washers 23, and a second metal washer 30 can be provided at the first elongated fasteners 17 between the second nut 29 and the third ceramic washers 28. Spring washers (not illustrated) such as a least one Belleville washer can also be provided at the first elongated fasteners 17 between the first nut 22 and the second ceramic washers 23 and be provided at the first elongated fasteners 17 between the t nut 29 and the third ceramic washers 28 to compensate for creeping.

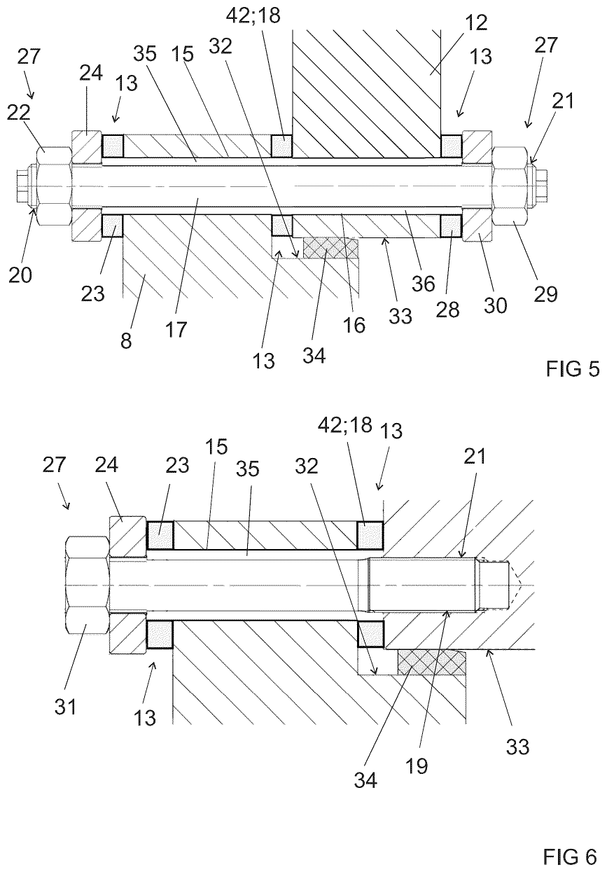

If the first fastening means 11 comprises pressing means 27, the pressing means 27 can, as in the first embodiment of the pod propulsion unit 1 illustrated in FIG. 2, as in the second embodiment of the pod propulsion unit 1 illustrated in FIG. 3, as in the fourth embodiment of the pod propulsion unit 1 illustrated in FIG. 6, as in the sixth embodiment of the pod propulsion unit 1 illustrated in FIG. 8, and as in the ninth embodiment of the pod propulsion unit 1 illustrated in FIGS. 11 to 13, comprise an inner threading 19 in the second holes 16 in the housing 2, wherein the inner threading 19 in the second holes 16 in the housing 2 being configured to threadingly engage a second outer threaded end section 21 of the first elongated fasteners 17 outside the aligned first holes 15 and second holes 16 so as to anchor the first elongated fasteners 17 in the second holes 16 in the housing 2. If the housing 2 is provided with a first frame means 12 in which the second holes 16 are provided and if the first fastening means 11 comprises pressing means 27, the pressing means 27 can, as in the first embodiment of the pod propulsion unit 1 illustrated in FIG. 2, as in the second embodiment of the pod propulsion unit 1 illustrated in FIG. 3, as in the fourth embodiment of the pod propulsion unit 1 illustrated in FIG. 6, as in the sixth embodiment of the pod propulsion unit 1 illustrated in FIG. 8, and as in the ninth embodiment of the pod propulsion unit 1 illustrated in FIGS. 11 to 13, comprise an inner threading 19 in the second holes 16 in the first frame means 12 of the housing 2, wherein the inner threading 19 in the second holes 16 in the first frame means 12 of the housing 2 being configured to threadingly engage a second outer threaded end section 21 of the first elongated fasteners 17 outside the aligned first holes 15 and second holes 16 so as to anchor the first elongated fasteners 17 in the second holes 16 in the first frame means 12 of the housing 2.

If the first fastening means 11 comprises pressing means 27, the pressing means 27 can as 6 in the fourth embodiment of the pod propulsion unit 1 illustrated in FIG. 6, as in the sixth embodiment of the pod propulsion unit 1 illustrated in FIG. 8, as in the seventh embodiment of the pod propulsion unit 1 illustrated in FIG. 9, and as in the eighth embodiment of the pod propulsion unit 1 illustrated in FIG. 10, comprise a head 31 integrally provided at the first elongated fasteners 17, wherein the head 31 being configured to press the first bearing housing 7 and the housing 2 towards each other. In practice this means that the first elongated fasteners 17 can be headed bolts. If the first bearing housing 7 is provided with a first flange portion 8 in which the first holes 15 are provided and if the housing 2 is provided with a first frame means 12 in which the second holes 16 are provided and if the first fastening means 11 comprises pressing means 27, the pressing means 27 can as in the fourth embodiment of the pod propulsion unit 1 illustrated in FIG. 6, as in the sixth embodiment of the pod propulsion unit 1 illustrated in FIG. 8, as in the seventh embodiment of the pod propulsion unit 1 illustrated in FIG. 9, and as in the eighth embodiment of the pod propulsion unit 1 illustrated in FIG. 10, comprise a head 31 integrally provided at the first elongated fasteners 17, wherein the head 31 being configured to press the first flange portion 8 of the first bearing housing 7 and the first frame means 12 of the housing 2 towards each other. If the first fastening means 11 comprises pressing means 27 comprising heads 31 integrally provided at the first elongated fasteners 17, as presented, the first electrical insulation arrangement 13 comprising preferably, but not necessarily, as in the fourth embodiment of the pod propulsion unit 1 illustrated in FIG. 6, as in the sixth embodiment of the pod propulsion unit 1 illustrated in FIG. 8, as in the seventh embodiment of the pod propulsion unit 1 illustrated in FIG. 9, and as in the eighth embodiment of the pod propulsion unit 1 illustrated in FIG. 10, second ceramic washers 23 penetrated or passed through by said first elongated fasteners 17 arranged in aligned first holes 15 and second holes 16, wherein the second ceramic washers 23 contacting the first bearing housing 7 and contacting the heads 31 so as to space apart the first bearing housing 7 and the heads 31 from one another and so as to electrically insulate the first bearing housing 7 and the heads 31 from one another. If the first bearing housing 7 is provided with a first flange portion 8 in which the first holes 15 are provided and if the housing 2 is provided with a first frame means 12 in which the second holes 16 are provided and if the first fastening means 11 comprises pressing means 27 and if the first fastening means 11 comprises pressing means 27 comprising heads 31 integrally provided at the first elongated fasteners 17, as presented, the first electrical insulation arrangement 13 comprising preferably, but not necessarily, as in the fourth embodiment of the pod propulsion unit 1 illustrated in FIG. 6, as in the sixth embodiment of the pod propulsion unit 1 illustrated in FIG. 8, as in the seventh embodiment of the pod propulsion unit 1 illustrated in FIG. 9, and as in the eighth embodiment of the pod propulsion unit 1 illustrated in FIG. 10, second ceramic washers 23 penetrated or passed through by said first elongated fasteners 17 arranged in aligned first holes 15 and second holes 16, wherein the second ceramic washers 23 contacting the first flange portion 8 of the first bearing housing 7 and contacting the heads 31 so as to space apart the first flange portion 8 of the first bearing housing 7 and the heads 31 from one another and so as to electrically insulate the first flange portion 8 of the first bearing housing 7 and the heads 31 from one another. A first metal washer 24 can, as in the fourth embodiment of the pod propulsion unit 1 illustrated in FIG. 6, as in the sixth embodiment of the pod propulsion unit 1 illustrated in FIG. 8, as in the seventh embodiment of the pod propulsion unit 1 illustrated in FIG. 9, and as in the eighth embodiment of the pod propulsion unit 1 illustrated in FIG. 10, be provided at the first elongated fasteners 17 between the head 31 and the first ceramic washers 23.

The first holes 15 in the first bearing housing 7 are preferably, but not necessarily, as in the second embodiment of the pod propulsion unit 1 illustrated in FIG. 3, as in the fifth embodiment of the pod propulsion unit 1 illustrated in FIG. 7, as in the sixth embodiment of the pod propulsion unit 1 illustrated in FIG. 8, and as in the eighth embodiment of the pod propulsion unit 1 illustrated in FIG. 10, provided with a first depression 25 that at least partly surround the first hole 15, and the second holes 16 in the housing 2 are preferably, but not necessarily, provided with a second depression 26 that at least partly surround the second hole 16, wherein first ceramic insulators 42 in the form of first ceramic washers 18 contacting the first bearing housing 7 and contacting the housing 2 being arranged partly in the first depression 25 and being arranged partly in the second depression 26. An advantage of this is that this allows the first ceramic insulators 42 in the form of first ceramic washers 18 to transfer shear forces between the first bearing housing 7 and the housing 2. If the first bearing housing 7 is provided with a first flange portion 8 in which the first holes 15 are provided and if the housing 2 is provided with a first frame means 12 in which the second holes 16 are provided, the first holes 15 in the first flange portion 8 of the first bearing housing 7 are preferably, but not necessarily, as in the second embodiment of the pod propulsion unit 1 illustrated in FIG. 3, as in the fifth embodiment of the pod propulsion unit 1 illustrated in FIG. 7, as in the sixth embodiment of the pod propulsion unit 1 illustrated in FIG. 8, and as in the eighth embodiment of the pod propulsion unit 1 illustrated in FIG. 10, provided with a first depression 25 that at least partly surround the first hole 15, and the second holes 16 in the first frame means 12 of the housing 2 are preferably, but not necessarily, provided with a second depression 26 that at least partly surround the second hole 16, wherein the first ceramic insulators 42 in the form of first ceramic washers 18 contacting the first flange portion 8 of the first bearing housing 7 and contacting the first frame means 12 of the housing 2 being arranged partly in the first depression 25 and being arranged partly in the second depression 26. The shape and the dimensions of the first ceramic insulators 42 in the form of first ceramic washers 18 corresponds preferably, but not necessarily, at least partly to the shape and the dimensions of the first depressions 25, and the shape and the dimensions of the first ceramic insulators 42 in the form of first ceramic washers 18 corresponds preferably, but not necessarily, at least partly to the shape and the dimensions of the second depressions 26. It is for example possible that the first ceramic insulators 42 in the form of first ceramic washers 18 are ring shaped so that the first ceramic insulators 42 in the form of first ceramic washers 18 have an outer cylindric surface and an inner cylindric surface and it is for example possible that the first depression 25 have a cylindric shape or the shape of a part of a cylinder that the second depression 26 have a cylindric shape or the shape of a part of a cylinder so that the first depressions 25 are configured to hold the first ceramic insulators 42 in the form of first ceramic washers 18 with clearance fit, transition fit or interference fit, and so that the second depressions 26 are configured to hold the first ceramic insulators 42 in the form of first ceramic washers 18 with clearance fit, transition fit or interference fit. In such case, the inner diameter of the inner cylindric surface of the first ceramic insulators 42 in the form of first ceramic washers 18 is preferably, but not necessarily, larger than the outer diameter of said first elongated fasteners 17 of the first fastening means 11 at the first ceramic insulators 42 in the form of first ceramic washers 18.

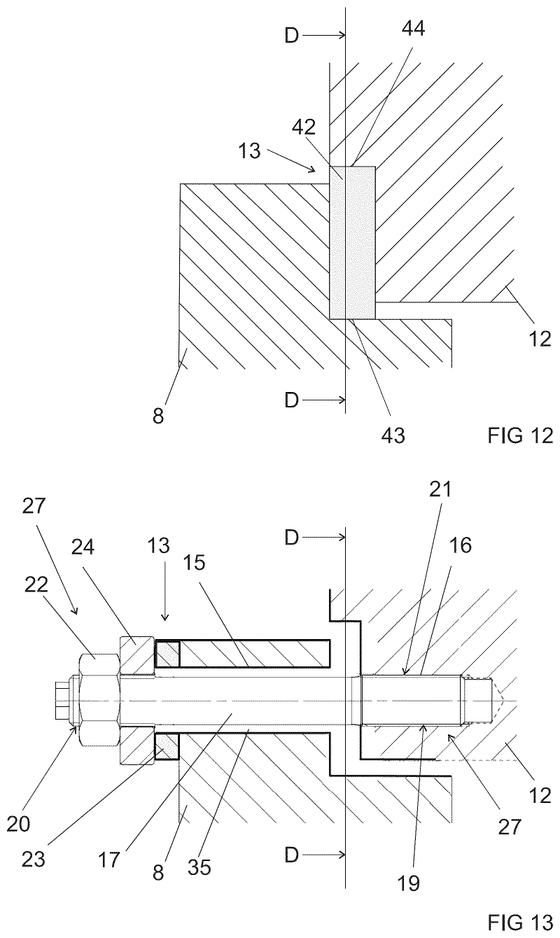

The first bearing housing 7 can be provided with third depressions 43 and the housing 2 can be provided with fourth depressions 44, wherein at least some of the first ceramic insulators 42 contacting the first bearing housing 7 and contacting the housing 2 are arranged partly in a third depression 43 and are arranged partly in the fourth depression 44. A detail view of a such embodiment of the pod propulsion is illustrated in FIGS. 11 to 13 as the ninth embodiment of the propulsion unit. In FIGS. 11 to 13, the first bearing housing 7 is provided with a first flange portion 8 and the third depressions 43 are provided in the first flange portion 8. In FIGS. 11 to 13, the housing 2 is provided with a first frame means 12 and the fourth depressions 44 are provided in the first frame means 12. An advantage of providing such third depressions 43 and fourth depressions 44 is that this allows the first ceramic insulators 42 to transfer shear forces between the first bearing housing 7 and the housing 2. It is possible that at least some of the first ceramic insulators 42 contacting the first bearing housing 7 and contacting the housing 2 have a cylindrical form so that said at least some of the first ceramic insulators 42 being arranged partly in a third depression 43 in the first bearing housing 7, which third depression 43 have a cylindric shape or the shape of a part of a cylinder so that said third depressions 43 is configured to hold the first ceramic insulator 42 with clearance fit, transition fit or interference fit in said third depressions 43 and so that said at least some of the first ceramic insulators 42 being arranged partly in a fourth depression 44 in the housing 2, which fourth depression 44 have a cylindric shape or the shape of a part of a cylinder so that said fourth depression 44 is configured to hold the first ceramic insulator 42 with clearance fit, transition fit or interference fit in said fourth depression 44. It is possible to provide the other embodiments of the propulsion unit with first ceramic insulators 42 partly arranged in first depressions 43 in the first bearing housing 7 and fourth depressions 44 in the housing 2 as illustrated in FIG. 12. The first bearing housing 7 can, as in the first embodiment of the pod propulsion unit 1 illustrated in FIG. 2, in the third embodiment of the pod propulsion unit 1 illustrated in FIG. 5, in the fourth embodiment of the pod propulsion unit 1 illustrated in FIG. 6, and in the eighth embodiment of the pod propulsion unit 1 illustrated in FIG. 10, comprise an outer circumferential surface portion 32 and the housing 2 can comprising an inner circumferential surface portion 33 that is surrounded by the inner circumferential surface portion 32 of the housing 2, wherein electrically insulating material 34 that is in contact with the outer circumferential surface portion 32 of the first bearing housing 7 and in contact with the inner circumferential surface portion 33 of the housing 2 is provided between the outer circumferential surface portion 32 of the first bearing housing 7 and the inner circumferential surface portion 33 of the housing 2 so as to transfer forces between the first bearing housing 7 and the housing 2. The electrically insulating material 34 can for example comprise epoxy reinforced glass fiber. It is also possible that electrically insulating material 34 comprise ceramic material. The electrically insulating material 34 can be in one-piece form or be formed by a plurality of pieces of electrically insulating material 34.

If the first bearing housing 7 is provided with third depressions 43 and if the housing 2 is provided with fourth depressions 44, so that at least some of the first ceramic insulators 42 contacting the first bearing housing 7 and contacting the housing 2 are arranged partly in a third depression 43 and are arranged partly in the fourth depression 44, the first fastening means 11 for fastening the bearing housing 7 to the pod housing 2 comprise, as in the embodiments of the pod propulsion unit illustrated in the figures, first elongated fasteners 17 arranged in aligned first holes 15 and second holes 16. Pressing means 27 configured to cooperate with the first elongated fasteners 17 so as to press the first bearing housing 7 and the housing 2 towards each other so that the first ceramic washers insulators 42 contacting the first bearing housing 7 and contacting the housing 2 are pressed between the first bearing housing 7 and the housing 2 are preferably, but not necessarily provided.

If the first bearing housing 7 is provided with third depressions 43 in a first flange portion 8 of the first bearing housing 7 and if the housing 2 is provided with fourth depressions 44 in a first frame means 12 of the housing 2, so that at least some of the first ceramic insulators 42 contacting the first flange portion 8 of the first bearing housing 7 and contacting the first frame means 12 of the housing 2 are arranged partly in a third depression 43 in the first flange portion 8 of the first bearing housing 7 and are arranged partly in the fourth depression 44 in the first frame means 12 of the housing 2, the first fastening means 11 for fastening the first flange portion 8 of the bearing housing 7 to the first frame means 12 of the pod housing 2 comprise, as in the embodiments of the pod propulsion unit illustrated in the figures, first elongated fasteners 17 arranged in aligned first holes 15 and second holes 16. Pressing means 27 configured to cooperate with the first elongated fasteners 17 so as to press the first flange portion 8 of the first bearing housing 7 and the first frame means 12 of the housing 2 towards each other so that the first ceramic washers insulators 42 contacting the first flange portion 8 of the first bearing housing 7 and contacting the first frame means 12 of the housing 2 are pressed between the first flange portion 8 of the first bearing housing 7 and the first frame means 12 of the housing 2 are preferably, but not necessarily provided, as illustrated in FIG. 13.

If the first bearing housing 7 is provided with third depressions 43 and if the housing 2 is provided with fourth depressions 44, so that at least some of the first ceramic insulators 42 contacting the first bearing housing 7 and contacting the housing 2 are arranged partly in a third depression 43 and are arranged partly in the fourth depression 44, the pod propulsion unit can additionally comprise first ceramic insulators 42, which are in the form of first ceramic washers 18, which are penetrated or passed through by the first elongated fasteners 17, which contact the bearing housing 7, and which contact the pod housing 2.

If the first bearing housing 7 is provided with third depressions 43 in a first flange portion 8 of the first bearing housing 7 and if the housing 2 is provided with fourth depressions 44 in a first frame means 12 of the housing 2, so that at least some of the first ceramic insulators 42 contacting the first flange portion 8 of the first bearing housing 7 and contacting the first frame means 12 of the housing 2 are arranged partly in a third depression 43 in the first flange portion 8 of the first bearing housing 7 and are arranged partly in the fourth depression 44 in the first frame means 12 of the housing 2, the pod propulsion unit can additionally comprise first ceramic insulators 42, which are in the form of first ceramic washers 18, which are penetrated or passed through by the first elongated fasteners 17, which contact the first flange portion 8 of the bearing housing 7, and which contact the first frame means 12 of the pod housing 2, as in the embodiments of the pod propulsion unit illustrated in the FIGS. 2 to 10.

The first bearing arrangement 6 is preferably, but not necessarily, provided at a so-called non-drive-end (NDE) of the pod propulsion unit 1 and the first bearing arrangement 6 can for example comprise a slide pad trust bearing (not illustrated in the figures) and an axially free roller support bearing (not illustrated in the figures) in the first bearing housing 7 of the first bearing arrangement 6.

The second bearing arrangement 9 is preferably, but not necessarily, provided at a so-called drive end (DE) of the pod propulsion unit 1 and the second bearing arrangement 9 can for example comprise an axially free roller support bearing (not illustrated in the figures) in a second bearing housing 10 of the second bearing arrangement 9. The second bearing housing 10 of the second bearing arrangement 9 comprises preferably, but not necessarily, second fastening means (not illustrated in the figures) for fastening the second bearing housing 10 of the second bearing arrangement 9 to the housing 2 of the pod propulsion arrangement 1. Grounding brushes (not illustrated in the figures) can be provided at the second bearing arrangement 9 electrically in contact with the propeller shaft 5 and in contact with the housing 2 to ground the propeller shaft 5 and to the housing 2.

The pod propulsion unit 1 comprises preferably, but not necessarily, as illustrated in FIG. 1, an electric motor 37 in the housing between the first bearing arrangement 6 and the second bearing arrangement 9 so that the rotor 38 and the stator 39 of the electric motor 37 coaxially surrounds the propeller shaft 5.

The support arm 3 comprises preferably, but not necessarily, as illustrated in FIG. 1, a turning arrangement 41 by means of which the pod propulsion unit 1 is connectable to the hull 4 of the marine vessel so that the pod propulsion unit 1 can be turned with respect to the hull 4 of the marine vessel.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A pod propulsion unit, comprising:
a housing;
a support arm attached to the housing and configured to fasten the housing to a hull of a marine vessel;
a propeller shaft that is rotatably supported within the housing with at least a first bearing arrangement having a first bearing housing and with at least a second bearing arrangement having a second bearing (10) housing;
first fastening means for fastening the first bearing housing to the housing, wherein the first bearing housing and the housing are spaced apart from one another by means of a first electrical insulation arrangement arranged between the first bearing housing and the housing and configured to electrically insulate the first bearing housing from the housing; and
a propeller attached to the propeller shaft;
wherein the first bearing housing has first holes aligned with second holes of the housing and forms aligned first holes and second holes;
wherein the first fastening means includes first elongated fasteners arranged in aligned first holes and second holes;
wherein the first electrical insulation arrangement includes first ceramic insulators; and
wherein the first ceramic insulators contact the first bearing housing and contact the housing so as to space apart the first bearing housing and the housing from one another.

2. The pod propulsion unit according to claim 1, wherein the first fastening means includes pressing means configured to cooperate with the first elongated fasteners so as to press the first bearing housing and the housing towards each other so that the first ceramic insulators contacting the first bearing housing and contacting the housing are pressed between the first bearing housing and the housing.

3. The pod propulsion unit according to claim 2, wherein the first elongated fasteners comprise a first outer threaded end section and the pressing means comprises a first nut threadingly engaging the first outer threaded end section.

4. The pod propulsion unit according to claim 3, wherein the first elongated fasteners comprise a second outer threaded end section and the pressing means comprises a second nut threadingly engaging the second outer threaded end section.

5. The pod propulsion unit according to claim 2, wherein the pressing means comprises an inner threading in the second holes in the housing and configured to threadingly engage a second outer threaded end section of the first elongated fasteners so as to anchor the first elongated fasteners in the second holes in the housing.

6. The pod propulsion unit according to claim 2, wherein the pressing means comprises a head integrally provided at the first elongated fasteners.

7. The pod propulsion unit according to claims 2, wherein the first electrical insulation arrangement comprises second ceramic washers penetrated by said first elongated fasteners arranged in aligned first holes and second holes, and wherein the second ceramic washers contact the first bearing housing and contact the pressing means so as to space apart the first bearing housing and the pressing means from one another.

8. The pod propulsion unit according to claim 2, wherein the first electrical insulation arrangement comprises third ceramic washers penetrated by the first elongated fasteners arranged in aligned first holes and second holes, and wherein the third ceramic washers contact the housing and contact the pressing means so as to space apart the housing and the pressing means from one another.

9. The pod propulsion unit according to claim 1, wherein at least some of the first ceramic insulators are formed as first ceramic washers penetrated by the first elongated fasteners arranged in the aligned first and second holes.

10. The pod propulsion unit according to claim 9, wherein the first holes in the first bearing housing are provided with a first depression that at least partly surrounds the first hole; wherein the second holes in the housing are provided with a second depression that at least partly surrounds the second hole; and wherein the first ceramic washers contact the first bearing housing and contact the housing, and are arranged partly in the first depression and are arranged partly in the second depression.

11. The pod propulsion unit according to claim 10, wherein the first ceramic washers are shaped at least partly to match a dimension of the first depressions, and wherein the first ceramic washers are shaped to at least partly match a shape and dimensions of the second depressions.

12. The pod propulsion unit of claim 10, wherein the first ceramic washers are ring shaped so that the first ceramic washers have an outer cylindrical surface and an inner cylindrical surface, wherein the first depression has a cylindrical shape, wherein the second depression has a cylindrical shape, wherein the first depression is configured to hold the first ceramic washers with one of a clearance fit, transition fit or interference fit, and wherein the second depression is configured to hold the first ceramic washer with one of a clearance fit, transition fit or interference fit.

13. The pod propulsion unit according to claim 1, wherein the first ceramic insulators are at least partially made form at least one of aluminum oxide and zirconium oxide.

14. The pod propulsion unit according to claim 1, wherein the first bearing housing comprises an outer circumferential surface portion, wherein the housing includes an inner circumferential surface portion, wherein the outer circumferential surface portion of the first bearing housing is surrounded by the inner circumferential surface portion of the housing, and wherein electrically insulating material is disposed between the outer circumferential surface portion of the first bearing housing and the inner circumferential surface portion of the housing.

15. The pod propulsion unit according to claim 1, wherein a diameter of the first elongated fasteners is smaller than a diameter of the first holes in the first bearing housing so that the first elongated fasteners and the first bearing housing are spaced apart from one another so as to provide a first electrically insulating air gap between the first elongated fasteners and the first bearing housing so as to electrically insulate the first elongated fasteners from the first bearing housing.

16. The pod propulsion unit according to claim 15, wherein a diameter of the first elongated fasteners is smaller than a diameter of the second holes in the housing at the second holes in the housing so that the first elongated fasteners and the housing are spaced apart from one another so as to provide a second electrically insulating air gap between the first elongated fasteners and the housing so as to electrically insulate the first elongated fasteners from the housing.

17. The pod propulsion unit according to claim 1, wherein the first bearing housing is provided with a first flange portion, and wherein the first holes are provided in the first flange portion.

18. The pod propulsion unit according to claim 1, wherein the housing is provided with a first frame means, and wherein the second holes are provided in the first frame means.

19. The pod propulsion unit according to claim 1, wherein the first bearing housing is provided with third depressions, the housing is provided with fourth depressions, and at least some of the first ceramic insulators contacting the first bearing housing and contacting the housing are arranged partly in one third depression and being arranged partly in one fourth depression.
